(19) United States
(12) Patent Application Publication
(10) Pub. No.: US 2025/0302063 A1
(43) Pub. Date: Oct. 2, 2025

(54) FAT COMPOSITIONS FOR BAKED GOODS

(71) Applicant: General Mills, Inc., Minneapolis, MN (US)

(72) Inventors: Kristin L. BAHE, Coon Rapids, MN (US); Catherine DAVLIN, Minneapolis, MN (US); Karsten KOTTE, Ham Lake, MN (US); Jon Duke SEIBOLD, Mahtomedi, MN (US)

(73) Assignee: General Mills, Inc., Minneapolis, MN (US)

(21) Appl. No.: 18/864,826

(22) PCT Filed: May 12, 2022
(86) PCT No.: PCT/US2022/028944

§ 371 Date: Nov. 11, 2024

(51) Int. Cl. A23D 9/013; A21D 2/16; A21D 10/02; A21D 13/16

(52) U.S. Cl. CPC A23D 9/013; A21D 2/165; A21D 10/025; A21D 13/16

(57) ABSTRACT

Anhydrous fat compositions are described that are solid at 20° C. and include about 3% to about 10% by weight of a lecithin, distilled monoglycerides having an iodine value of less than 50, or a combination thereof. Fat compositions described are suitable for use in making doughs that can be cooked to make baked goods that advantageously maintain an acceptable eating experience over a heated hold time, achieve better eating quality after reheating, and/or exhibit improved flakiness. Also described are methods of making such fat compositions, methods of making doughs containing such fat compositions, packaged and unpackaged doughs containing such fat compositions, methods of making baked goods using the described doughs, and baked goods made using the described doughs.

### BACKGROUND

Consumers want opportunities to enjoy baked goods at convenient times and/or convenient settings. Restaurants, bakeries, and other food-service businesses can provide consumers with fast, convenient baked goods by pre-baking enough baked goods to serve an anticipated demand. These baked goods can be held after baking in a heated state for a period of time before customers consume them. Unfortunately, such hold times can result in reduced quality over time and reduce the consumers' enjoyment of the baked good. Similarly, consumers enjoy making convenient baked goods from frozen or refrigerated dough to provide a home-made, fresh baked good eating experience. However, if these baked goods are not consumed immediately, consuming them after later reheating generally results in a less desirable eating experience. Thus, there is a need for convenient baked goods that still provide a good eating experience.

### SUMMARY

The present disclosure relates to fat compositions that extend a favorable eating experience in baked goods. Such fat compositions are anhydrous and contain lecithin and/or certain distilled monoglycerides in an amount of about 3% to about 10% by weight.

Provided herein are fat compositions. A fat composition provided herein is anhydrous and solid at 20° C., and consists of at least 99% by weight of a combination of: a. a first component consisting of a bakery compatible fat in an amount of about 90% to about 97% by weight of the composition; and b. a second component consisting of a lecithin, a distilled monoglyceride having an iodine value (IV) of less than 50, or a combination thereof, the second component included in an amount of about 3% to about 10% by weight of the composition.

In some embodiments, the second component consists of a soy lecithin, a sunflower lecithin, or a rapeseed/canola lecithin.

A fat composition provided herein can be in a form of chips or flakes.

Some embodiments of a flake-or chip-form fat composition can have a first component that has a Mettler Dropping Point (MDP) of greater than 25° C. (e.g., about 35° C. to about 60° C.), and consists essentially of palm oil, a palm oil fraction, palm kernel oil, a palm kernel oil fraction, a coconut oil, a coconut oil fraction, or any interesterified or non-interesterified combination thereof.

Some embodiments of a flake-or chip-form fat composition can have a first component that has a Mettler Dropping Point (MDP) of greater than 25° C. (e.g., about 45° C. to about 60° C.), consists essentially of an interesterified and/or non-interesterified combination of a liquid oil and a fully hydrogenated oil.

Some embodiments of a flake-or chip-form fat composition can have a second component that is included in an amount of about 5% to about 9% by weight of the composition.

A fat composition provided herein can be in a form of a laminating fat composition.

Some embodiments of a laminating fat composition can have a first component that has an MDP of greater than 25° C., and consists essentially of a blend of: a. a hard fat consisting essentially of palm oil, a palm oil fraction, a fully hydrogenated palm oil or palm oil fraction, palm kernel oil, a palm kernel oil fraction, a fully hydrogenated palm kernel oil or palm kernel oil fraction, or any interesterified or non-interesterified combination thereof; and b. a liquid oil.

Some embodiments of a laminating fat composition can have a second component that is included in an amount of about 3% to about 8% by weight of the composition.

A dough is provided herein that includes a fat composition described herein.

A method of making a baked good is also provided. A method of making a baked good can include cooking a dough that contains a fat composition described herein to produce a ready-to-eat baked good or par-cooked baked good.

A baked good made according to a disclosed method of making a baked good is also provided.

A method of making a packaged refrigerated or frozen dough is provided herein. A method of making a packaged refrigerated or frozen dough can include: a. combining a flour, water, and the fat composition of any one of claims 1-10 to produce a dough; b. forming the dough into portions; c. refrigerating or freezing the portions; and d. packaging the portions.

A fat composition used in a method of making a packaged refrigerated or frozen dough (e.g., a biscuit dough, a pizza dough, a bread dough, pie crust dough, or a pastry dough) can be in a form of chips or flakes, where the chips or flakes are included in an amount of about 5% to about 25% by weight of the dough, and the chips or flakes are distributed throughout the dough.

A fat composition used in a method of making a packaged refrigerated or frozen dough (e.g., a croissant dough or a puff pastry dough) can be in a form of a laminating fat composition, where the fat composition is included in an amount of about 5% to about 40% by weight of the dough, and the dough contains the fat composition in laminated layers.

A packaged dough product is provided herein that includes packaged portions of a refrigerated or frozen dough made according to a method of making a refrigerated or frozen dough described herein.

A method of making a baked good is also provided, the method including cooking a dough from a packaged dough product described herein to produce a ready-to-eat baked good or par-cooked baked good.

Also provided herein is a baked good made according to a method of making a baked good described herein.

A method of making a packaged baked good is provided herein. A method of making a packaged baked good can include: a. combining a flour, water, and the fat composition of any one of claims 1-10 to produce a dough; b. forming the dough into portions; c. baking the portions to produce a baked good; and d. packaging the baked good.

In some embodiments, a method of making a packaged baked good includes refrigerating or freezing the baked good. In some embodiments, a baked good is a par baked refrigerated or frozen baked good.

In some embodiments, in a method of making a packaged baked good, the baked good is ready-to-eat.

In some embodiments, in a method of making a packaged baked good, the fat composition can be in a form of chips or flakes, the chips or flakes are included in an amount of 5% to about 25% by weight of the dough, and the chips or flakes are distributed throughout the dough. In some embodiments, the dough can be a biscuit dough, a pizza dough, a bread dough, a pie crust dough, or a pastry dough.

In some embodiments, in a method of making a packaged baked good, the fat composition can be in a form of a laminating fat composition included in an amount of about 5% to about 40% by weight of the dough, and the dough contains the fat composition in laminated layers. In some embodiments, the dough can be a croissant dough or a puff pastry dough.

Also provided is a packaged baked good made according to a method of making a packaged baked good described herein.

These and various other features and advantages will be apparent from a reading of the following detailed description.

### BRIEF DESCRIPTION OF DRAWINGS

FIG. 1 shows pictures of a whole pastry roll and a pastry roll cut in half made using a laminated dough containing a control anhydrous laminating fat, shown from a top view (left) and a top perspective view (right).

FIG. 2 shows pictures of a pastry roll made using an inventive laminated dough containing a laminating fat containing 3.5% soy lecithin, shown from a top view (left) and a top perspective view (right).

FIG. 3 shows pictures of a pastry roll made using an inventive laminated dough containing a laminating fat containing 7% soy lecithin, shown from a top view (left) and a top perspective view (right).

### DETAILED DESCRIPTION

Baked goods at restaurants, bakeries, and other food-service businesses are often baked ahead to serve an anticipated demand. After baking, such baked goods may be held in a warming oven, under a heating lamp, or reheated in an attempt to provide a fresh-baked experience. Unfortunately, heated hold times can result in reduced quality over time and reduce the consumers' enjoyment of the baked good. Similarly, later reheating generally results in a less desirable eating experience.

To improve the quality of baked goods over extended heated hold times, it was discovered that anhydrous fat compositions that are described herein that include about 3% to about 10% by weight of certain emulsifiers can provide one or more unexpected benefit after baking. It was discovered that inclusion of a described fat composition in a dough can prolong a good eating experience during an extended heated state following baking, such as sometimes employed in food service settings. For example, a baked good made using a fat composition provided herein can maintain acceptable eating quality over a heated hold time of 150° F. for times that exceed control by at least 30 minutes (e.g., at least 60 minutes, at least 90 minutes, at least 120 minutes, at least 180 minutes, or at least 240 minutes). In some cases, inclusion of a described fat composition in a dough can improve the eating quality of a reheated baked good. For example, a baked good that has been baked and then held at room temperature and reheated in an oven or a microwave oven can have an eating quality that is significantly improved over control. It was also discovered that the described fat compositions included in baked goods made from laminated doughs can increase flakiness, a trait consumers enjoy in such baked goods.

While small amounts of emulsifiers are sometimes included in anhydrous fat compositions to improve handling characteristics, such as including small amounts of lecithin in shortening chips to prevent adhesion to one another, emulsifiers are more typically included in hydrated fats to maintain emulsions. In addition, many emulsifiers are believed to negatively affect flavor characteristics of fat compositions when included in higher amounts. Thus, prior to the present discovery, it was commonly believed to be best practice to limit the amount of emulsifier included in a fat composition to levels sufficient to achieve handling benefits (typically less than 1% by weight) or to maintain an emulsion (typically less than 5% by weight).

Although fat compositions described herein do not require inclusion of emulsifiers to maintain an emulsion because they are anhydrous (i.e., contains less than 0.1% water), it was found that certain emulsifiers, including lecithin and distilled monoglycerides having an iodine value (IV) of less than 50 (e.g., about 30 to about 48, or about 35 to about 45), surprisingly produce one or more of the described beneficial effects when included in amounts of about 3% to about 10% by weight of the described fat compositions, while other emulsifiers have no effect. It is even more surprising that, although the described fat compositions contain relatively high levels of emulsifier, there is little to no negative impact on flavor when used in baked goods at levels typically used for fats that have much lower emulsifier levels.

A fat composition provided herein consists of (by weight of the fat composition) a first component in an amount of about 90% to about 97%, a second component in an amount of about 3% to about 10%, and less than 1% (e.g., less than 0.5%, or 0%) any other component.

The first component in a fat composition is a bakery compatible fat. As used herein, a “bakery compatible fat” refers to an edible triglyceride composition suitable for use in baked goods. A bakery compatible fat is generally solid at 20° C., but can contain non-interesterified or interesterified blends that include one or more liquid oil (e.g., soybean oil, sunflower oil, or the like). A bakery compatible fat can be in any suitable form, such as a solid chip or flake, or a laminating fat (also sometimes called “roll-in fat”). A bakery compatible fat suitable for use in a fat composition provided herein is anhydrous. Although a bakery compatible fat is a triglyceride composition, it may contain minor amounts of naturally occurring free fatty acids, diglycerides, and other compounds. For example, palm oil can contain up to 4-8% naturally occurring diglycerides, while soybean oil typically contains less than 2% of naturally occurring diglycerides. Thus, a fat composition herein may contain such naturally occurring compounds as contributed by a bakery compatible fat.

Any bakery compatible fat can be a first component in a composition provided herein so long as it fits the above description. For example, a suitable bakery compatible fat can have a Mettler Dropping Point (MDP) of greater than 25° C. (e.g., about 35° C. to about 60° C., about 35° C. to about 50° C., about 45° C. to about 60° C., or about 50° C. to about 60° C.). As used herein, MDP is measured according to AOCS Cc 18-80 (Firestone, D. (Ed.). (2009). Official Methods and Recommended Practices of the AOCS (6^{th} ed.). AOCS Press.).

A suitable bakery compatible fat can include a single non-interesterified or interesterified fat type, any non-interesterified or interesterified blends of fat types, where the fat types within a blend can be interesterified or non-interesterified. Examples of fat types include whole fats or oils, or fractions and/or fully hydrogenated versions thereof, such as, without limitation, palm oil, palm kernel oil, coconut oil, soybean oil, sunflower oil, corn oil, canola/rapeseed oil, cottonseed oil, or the like.

Particularly suitable bakery compatible fats include, for example, shortening chips or flakes with an MDP greater than 25° C. (e.g., from about 40° C. to about 60° C.) that consist essentially of palm oil, a palm oil fraction, palm kernel oil, a palm kernel oil fraction, a coconut oil, a coconut oil fraction, or any interesterified or non-interesterified combination thereof. Another example of a particularly suitable bakery compatible fat includes shortening chips or flakes with an MDP greater than 25° C. (e.g., from about 50° C. to about 65° C.) that consist essentially of an interesterified and/or non-interesterified combination of a liquid oil and a fully hydrogenated oil. Another example of a particularly suitable bakery compatible fat includes a laminating fat with an MDP greater than 25° C. (e.g., from about (e.g., from about 50° C. to about 65° C., or from about 50° C. to about 55° C.) that consists essentially of a hard fat consisting essentially of palm oil, a palm oil fraction, a fully hydrogenated palm oil or palm oil fraction, palm kernel oil, a palm kernel oil fraction, a fully hydrogenated palm kernel oil or palm kernel oil fraction, or any interesterified or non-interesterified combination thereof; and a liquid oil.

As used herein, the term “consists essentially of” indicates that no more than 2% (e.g., no more than 1.5%, or no more than 1%) by weight of any other component than those described may be included in a composition. For example, a bakery compatible fat consisting essentially of palm oil, a palm oil fraction, palm kernel oil, a palm kernel oil fraction, a coconut oil, a coconut oil fraction, or any interesterified or non-interesterified combination thereof means that the bakery compatible fat consists of at least 98% of the listed contents (i.e., palm oil, a palm oil fraction, palm kernel oil, a palm kernel oil fraction, a coconut oil, a coconut oil fraction, or any interesterified or non-interesterified combination thereof) by weight, and no more than a total of 2% other components, such as emulsifiers (e.g., lecithin, mono-and di-glycerides, and the like), antioxidants (e.g., TBHQ), colorants (e.g., beta carotene), and the like.

The second component in a fat composition is one or a combination of suitable emulsifiers. Suitable emulsifiers include lecithin (e.g., soy lecithin, sunflower lecithin, rape seed lecithin, and the like) and distilled monoglycerides that have an iodine value (IV) of less than 50 (e.g., an IV of about 30 to about 48, or about 35 to about 45). Lecithins, particularly soy lecithin, are especially effective in a fat composition provided herein. However, it was found that all of the lecithin sources that were tested were effective, and the described distilled monoglycerides were also effective. Suitable distilled monoglycerides can be derived from any appropriate source, including for example, palm oil, palm oil stearin, hydrogenated oils (e.g., palm, soy, canola/rapeseed, and the like), and blends of oils. As used herein, iodine value (IV) is measured by cyclohexane-acetic acid method according to AOCS Cd 1d-92 ((2017). Official Methods and Recommended Practices of the AOCS (7^{th} ed.). AOCS Press.).

The second component in a fat composition is included in an amount of about 3% to about 10% (e.g., about 3% to about 8%, or about 5% to about 9%) by weight of the fat composition. In some cases, where a fat composition is included at higher levels in a dough, it might be preferred to keep the second component content to about 8% or less in the fat composition to avoid significant flavor impact. It is to be understood that, because some bakery compatible fats already contain small amounts of lecithin and/or monoglycerides (typically, less than 1% by weight), the total measurable amount of lecithin and/or monoglycerides in a fat composition may exceed 10%, but in many cases, does not exceed 12%. However, a fat composition provided herein can contain more than 12% lecithin and/or monoglycerides, especially if the fat composition is used in making a baked good in which the flavor is not significantly negatively impacted, or where the lecithin and/or monoglycerides do not become cost prohibitive.

It is preferred that the second component is blended with the first component so that the second component is distributed throughout a fat composition. For example, a first component can be melted (e.g., heated to a temperature at or above its MDP, such as a temperature at least 5° C. above its MDP) and mixed with a second component to distribute the second component throughout the first component to produce a fat composition described herein. Blending a first component with a second component can be performed using any appropriate equipment. After blending, a fat composition can be further processed using known methods, such as forming into flakes or chips. A fat composition can be formed into flakes or chips by applying the fat composition in liquid form to a chilled drum or belt, then fracturing the resulting solid fat into the desired flakes or chips. Examples of chilled drums or belts include, for example, Sandvik Belt Flaker manufactured by Hampford Research Inc (Stratford, CT, USA), or a cooling drum flaker manufactured by Buflovak (Buffalo, NY, USA). In another example, a fat composition can be processed via a scraped surface heat exchanger. Examples of scraped surface heat exchangers include, for example, Votator® II manufactured by Waukesha Cherry-Burrell® (Delevan, WI, USA), Contherm manufactured by Alfa Laval, Inc. (Richmond, VA, USA), Terlotherm manufactured by Terlet BV (Zutphen, Netherlands), and Gerstenberg Schroder Kombinator manufactured by SPXFlow (Soeborg, Denmark).

Alternatively, for fat compositions that are in the form of a chip or a flake, application of the second component on the surface of the first component can provide a similar benefit as distribution of the second component within the first component.

For application of a second component onto a surface of a first component in the form of a flake or a chip, the second component can be sprayed, painted, or otherwise applied to the surface of the first component and allowed to set. In some embodiments, a second component can be mixed with an oil to facilitate application to the surface of a first component chip or flake. However, a second component may be more susceptible to shedding into a dough if it is on the surface of a flake or a chip than if it is blended with the first component.

It was discovered that the second component (lecithin or distilled monoglycerides) does not provide any benefit, and in fact may reduce eating quality, e.g., resulting in mass cohesion during eating of the resulting baked good, if the second component is combined with a dough without being associated directly with a bakery compatible fat.

Upon discovery that lecithin produced the above-described benefits in a fat composition, it was initially believed that the effect was due to the emulsifying properties of lecithin. However, further experiments unexpectedly demonstrated that lecithin and the described distilled monoglycerides provided benefits described above, but other tested emulsifiers, such as PGPR 90, calcium stearoyl lactylate (CSL), non-distilled monoglycerides, and distilled soft monoglycerides having an IV above 50, did not. Further, beneficial effects of lecithin did not depend on hydrophilic-lipophilic balance (HLB), since lecithins with HLB values ranging from 4 to 12 were found to benefit eating quality of baked goods over an extended heated hold time with no apparent link of effectiveness to HLB value.

In another alternative, it was believed that the beneficial effects of a described fat composition could be due to promotion by lecithin of a particular crystalline structure in fat and/or by preventing recrystallization of fat after baking. However, testing crystal formation in various bakery compatible fats with and without inclusion of lecithin provided mixed results, with no pattern in crystallization being apparent. Upon testing, a soybean oil-based shortening chip lost a beta polymorph crystal with the addition of 7% soy lecithin; a palm stearin-based shortening chip gained a dominant beta polymorph with the addition of 7% soy lecithin; and a palm oil and palm kernel oil-based shortening chip exhibited little change in crystal structure with the addition of 7% soy lecithin. Yet, surprisingly, each of the tested fats exhibited extension of baked good quality when including a second component, regardless of the effect on crystal formation.

Crystal formation type was determined using x-ray diffraction analysis of fats (XRD). XRD is performed using a TERRA Mobile XRD System (Olympus Scientific Solutions Americas Inc., Waltham, MA, USA) by pressing a sample onto the window of the sample plate without compressing the sample in a particular direction or pressing excessively, and measuring x-ray diffraction according to the manufacturer's instructions. The results of XRD are graphed with diffraction angle in degrees 2θ (2-theta) along the x-axis and intensity of signal along the y-axis. A beta tending crystal forming fat composition has a prominent peak, as determined by peak signal intensity, around 22.4° 2θ, while a beta prime tending forming fat composition has a prominent peak, as determined by peak signal intensity, around 24.6° 2θ and a secondary peak around 27.2° 2θ.

A fat composition provided herein can be combined with a flour and water to produce a dough that can be cooked to produce a baked good. As used herein, the term “dough” refers to an uncooked product that can be cooked to make a baked good, while “baked good” refers to a food that is either fully cooked and ready-to-eat, or par-cooked and requiring some additional cooking prior to eating. Such baked goods include, for example, biscuits, pizza crust, pie crust, pastries (e.g., croissants, sweet rolls, puff pastries, and the like), breads, and the like. While a dough provided herein is typically cooked by baking, in some cases, a dough provided herein may be cooked by other means, such as frying (e.g., a donut), steaming, or microwaving.

A dough provided herein can be made using any suitable method or formulation that includes incorporation of a fat composition described herein. For example, a fat composition in the form of chips or flakes can be mixed with flour and water to form a dough, where the chips or flakes are incorporated throughout the dough. Such a dough might suitably be formulated to produce a biscuit, a pizza crust, a pie crust, a bread, or a pastry such as a sweet roll. A fat composition provided herein can be included in any suitable amount for such a dough. For example, a fat composition may suitably be included in the form of a chip or a flake in an amount of about 5% to about 25% (e.g., about 10% to about 20%, or about 10% to about 15%) by weight of a dough. A dough provided herein can be made using any appropriate equipment and conditions, including using home or commercial kitchen equipment, or using industrial scale food manufacturing equipment.

In another example, a fat composition in the form of a laminating fat composition can be included in a dough as laminated layers. Such a dough might suitably be formulated to produce a croissant, puff pastry, or the like. A fat composition provided herein can be included in any suitable amount for such a dough. For example, a fat composition may suitably be included in the form of a laminating fat composition in an amount of about 5% to about 40% (e.g., about 10% to about 35%, or about 12% to about 35%) by weight of a dough.

Any appropriate ingredients, aside from a fat composition provided herein, can be used to make a dough. For example, a flour can include one or a combination of a grain flour (e.g., wheat, oat, barley, rye, rice, or the like, or any combination thereof), a seed flour (e.g., buckwheat, quinoa, sunflower, or the like, or any combination thereof), a legume flour (e.g., soybean, peanut, lentil, or the like, or any combination thereof), a nut flour (e.g., almond, coconut, and the like, or any combination thereof), a tuber flour (e.g., potato, cassava, or the like, or any combination thereof), or any other flour suitable for making a baked good. Other suitable ingredients can be included in a dough provided herein, such as sugar, leavening ingredients (e.g., yeast, leavening acid/base combinations, or the like), inclusions (e.g., dried fruit, confectionery pieces, chocolate, or the like), salt, flavorants, dairy and/or egg ingredients, dough conditioners, preservatives, and the like. Water content in a dough can be included in an amount suitable for the dough type desired. In some embodiments, a dough can include additional bakery compatible fats or oils that do not include a second component. Thus, a dough provided herein can have a fat content that is higher than the amount of included fat composition. General formulations for doughs suitable for making some various baked goods are provided in Table 1. In Table 1 “fat composition” refers to a fat composition provided herein, while “other ingredients” can, in some embodiments, include bakery compatible fats or oils that have less than 3% lecithin and/or distilled monoglycerides.

TABLE 1

| Baked good | Flour (by | Water (by | Fat | Other |
|---|---|---|---|---|
| type | weight) | weight) | composition | ingredients |
| Biscuit | 40-60% | 25-35% | 10-20% | 5-25% |
| Pizza crust | 45-65% | 25-35% | Up to 10% | 5-25% |
| Pie crust | 40-60% | 15-25% | 20-30% | 5-25% |
| Bread | 40-60% | 20-30% | Up to 10% | 5-25% |
| Sweet roll | 40-60% | 10-25% | 2-20% | 5-25% |
| Croissant | 25-45% | 25-35% | 20-40% | 5-25% |
| Puff | 40-60% | 15-30% | 25-45% | 5-25% |
| pastry/phyllo | | | | |

A dough provided herein can be formed into portions and either packaged as a refrigerated or frozen dough, or cooked and packaged as a ready-to-eat or par-cooked baked good. A packaged dough can be formed into portions suitable for making a single baked good from the portion, or into a larger dough portion that can be cooked and then portioned, or portioned and then cooked. For example, a packaged dough can be formed into biscuit dough pucks that can be cooked, such that each puck forms a finished biscuit. In another example, a larger packaged dough portion can be reportioned into smaller portions to be cooked into bread loaves. In yet another example, a larger packaged dough portion can be cooked into a focaccia bread loaf and then portioned after cooking into pieces.

A packaged dough provided herein can be a refrigerated or frozen dough. In some cases, the dough can be formulated to require a rest period prior to cooking, for example to thaw, reach room temperature, and/or to proof. In some cases, a dough can be formulated as refrigerator-to-oven dough or freezer-to-oven dough. As used herein, the term “refrigerator-to-oven dough” refers to a dough that is formulated to be able to be taken from a cooler or refrigerator and cooked directly (e.g., in an oven, fryer, steamer, or microwave) without requiring a rest period. As used herein, the term “freezer-to-oven dough” refers to a dough that is formulated to be able to be taken from a freezer and cooked directly (e.g., in an oven, fryer, steamer, or microwave) without requiring a rest period.

In some embodiments, a portioned dough can be fully cooked (i.e., ready-to-eat) or par cooked and packaged to produce a packaged baked good. A packaged baked good can be stored at any temperature (e.g., heated, room temperature, refrigerated, or frozen). A fully cooked packaged baked good may be considered a “ready-to-eat baked good” even if it is stored at refrigerated or frozen temperatures, so long as no further cooking is necessary for consumption. As such, a ready-to-eat baked good that is stored at room temperature, refrigerated, or frozen may be heated to improve the eating experience, but heating is not necessary to render it fully cooked.

While a par-cooked baked good that is stored at room temperature generally needs only be further cooked without any rest period, in some embodiments, a par-cooked packaged baked good that is refrigerated or frozen can be formulated to require a rest period prior to further cooking, for example to thaw or reach room temperature. In some embodiments, a par-cooked packaged baked good can be formulated as a refrigerator-to-oven baked good or freezer-to-oven baked good. As used herein, the term “refrigerator-to-oven baked good” refers to a baked good that is formulated to be able to be taken from a cooler or refrigerator and cooked directly (e.g., in an oven, fryer, steamer, or microwave) without requiring a rest period. As used herein, the term “freezer-to-oven baked good” refers to a baked good that is formulated to be able to be taken from a freezer and cooked directly (e.g., in an oven, fryer, steamer, or microwave) without requiring a rest period.

The following examples are provided to show selected embodiments of the invention described herein. The examples are not intended to limit the invention to any particular embodiment.

### EXAMPLES

### Example 1—Fat Compositions

Fat compositions were produced by blending bakery compatible fats with lecithin, distilled monoglycerides, undistilled monoglycerides, or other emulsifiers, as set forth in Table 2. Briefly, if indicated as “blended,” each composition was made by melting each indicated component, typically at a temperature at least 5° C. greater than its MDP, and blending the molten ingredients together to create a molten mixture. Fat chips were made by depositing the molten mixture onto a cold surface (typically −18° C. to −6° C.) and cooling to create a solid sheet of the fat composition, with sheets being approximately 0.042 inches thick. The sheet is fractured into irregular pieces to form fat composition chips. If indicated as “topical,” the second component was mixed with a soybean oil and painted onto the surface of the appropriate fat chip with a brush, and then the painted chips were chilled to solidify the second component on the surface. Fat chip A is a palm oil and palm kernel oil-based shortening chip with an MDP of about 44-46° C.; fat chip B is a palm oil-based shortening chip with an MDP of about 54-55° C.; fat chip C is a soybean oil-based shortening chip with an MDP of about 58-60° C.; and laminating fat A is a soybean and palm-based shortening with an MDP of about 53-54° C.

TABLE 2
Component

| | First Component | | Second |
|---|---|---|---|
| Fat | (Bakery compatible | Second Component | Component |
| composition | fat) | (Emulsifier) | application |
| Control A | Fat chip A | NA* | NA |
| 1 | Fat chip A | 8% soy lecithin (HLB 4) | Blended** |
| 2 | Fat chip A | 8% soy lecithin (HLB 4) | Topical*** |
| 3 | Fat chip A | 7% soy lecithin (HLB 4) | Blended |
| 4 | Fat chip A | 7% soy lecithin (HLB 4) | Topical |
| 5 | Fat chip A | 6% soy lecithin (HLB 4) | Blended |
| 6 | Fat chip A | 6% soy lecithin (HLB 4) | Topical |
| 7 | Fat chip A | 5% soy lecithin (HLB 4) | Blended |
| 8 | Fat chip A | 3% soy lecithin (HLB 4) | Topical |
| 9 | Fat chip A | 7% soy lecithin (HLB 4) | Topical |
| 10 | Fat chip A | 7% soy lecithin (HLB 4) | Blended |
| 11 | Fat chip A | 7% soy lecithin (HLB 12) | Blended |
| 12 | Fat chip A | 7% refined soy lecithin A | Topical |
| | | (HLB 7-8) | |
| 13 | Fat chip A | 7% refined soy lecithin A | Blended |
| | | (HLB 7-8) | |
| 14 | Fat chip A | 7% refined soy lecithin B | Topical |
| | | (HLB 7-8) | |
| 15 | Fat chip A | 7% hydroxylated soy | Topical |
| | | lecithin (HLB 9-10) | |
| 16 | Fat chip A | 7% sunflower lecithin | Blended |
| 17 | Fat chip A | 7% rapeseed lecithin | Blended |
| 18 | Fat chip A | 7% distilled palm-based | Blended |
| | | monoglyceride (IV ~45) | |
| 19 | Fat chip A | 7% distilled palm-based | Blended |
| | | monoglyceride (IV ~35-45) | |
| 20 | Fat chip A | 7% PGPR 90 | Topical |
| 21 | Fat chip A | 7% non-distilled palm- | Blended |
| | | based monoglyceride (IV ~50) | |
| 22 | Fat chip A | 7% non-distilled palm- | Blended |
| | | based monoglyceride (IV <4) | |
| 23 | Fat chip A | 7% CSL | Blended |
| 24 | Fat chip A | 7% distilled sunflower- | Blended |
| | | based monoglyceride (IV >100) | |
| Control B | Fat chip B | NA | NA |
| 25 | Fat chip B | 7% soy lecithin | Blended |
| Control C | Fat chip C | NA | NA |
| 26 | Fat chip C | 5% soy lecithin | Blended |
| Control D | Laminating fat A | NA | NA |
| 27 | Laminating fat A | 3.5% soy lecithin | Blended |
| 28 | Laminating fat A | 7% soy lecithin | Blended |

*NA = not applicable
**Blended = First component and second component were blended
***Topical = Second component applied to the surface of first component

### Example 2—Biscuits

Biscuit doughs formulated as freezer-to-oven dough suitable for food service use were made using each of fat compositions 1-26, and the appropriate controls. The biscuit doughs were formulated to contain 10-20% by weight of the respective fat composition. Briefly, the doughs were made as follows: the selected fat composition was blended with flour to distribute the chips throughout the flour, and then water and butter flavor were added, and the mixture was further mixed to produce a dough. The dough was cut to produce round dough pieces and frozen. To test the quality of a baked good made from each dough over a heated hold time, the frozen dough was baked at 325° F. in a convection oven with a high fan speed for 17-22 minutes to produce fully cooked biscuits. Following baking, biscuits were held in a 150° F. oven and evaluated at 0, 30, 60, 90, 120, 150, 180, and 210 minutes, with samples 1-6 also being evaluated at 270 and 330 minutes. Each biscuit was deemed acceptable, marginally acceptable, or unacceptable based on its eating qualities (e.g., texture, flavor, moistness). Control A typically remained acceptable for at least 60 minutes, but in each experiment, it was marginally acceptable at 90 minutes, and unacceptable by 150 minutes. Control B typically remained acceptable for at least 90 minutes, but it generally found to be marginally acceptable at 120 minutes, and unacceptable by 180 minutes. Control C typically remained acceptable for at least 60 minutes, but it generally found to be marginally acceptable at 90 minutes, and unacceptable by 150 minutes. Table 3 shows the time interval last evaluated to be acceptable and marginally acceptable for each sample, and the first time interval each sample was evaluated as unacceptable. Table 3 also indicates how much longer a sample remains acceptable after the appropriate control sample is last evaluated to be acceptable. Samples have the same number as the included fat composition from Table 2.

TABLE 3

| | | | Last | | Time |
|---|---|---|---|---|---|
| | Second | Last | marginally | First | exceeding |
| | component | acceptable | acceptable | unacceptable | control |
| Sample | type⁺⁺ | (minutes) | (minutes) | (minutes) | (minutes) |
| Control | NA* | 60 | 120 | 150 | NA |
| A | | | | | |
| 1 | L | 330 | ** | NA | >240 |
| 2 | L | 330 | NA | NA | >270 |
| 3 | L | 270 | 330 | *** | 210 |
| 4 | L | 270 | 330 | *** | 210 |
| 5 | L | 210 | 270 | 330 | 150 |
| 6 | L | 210 | 270 | 330 | 150 |
| 7 | L | 180 | 210 | *** | 120 |
| 8 | L | 180 | ND⁺ | 210 | 120 |
| 9 | L | 210 | ** | ** | >150 |
| 10 | L | 120 | 150 | 180 | 60 |
| 11 | L | 210 | ** | ** | >150 |
| 12 | L | 210 | ** | ** | >150 |
| 13 | L | 120 | 150 | 180 | 60 |
| 14 | L | 150 | 210 | *** | 90 |
| 15 | L | 150 | 180 | 210 | 90 |
| 16 | L | 210 | ** | ** | >150 |
| 17 | L | 180 | 210 | *** | 120 |
| 18 | DM | 150 | 180 | 210 | 90 |
| 19 | DM | 90 | 150 | 180 | 30 |
| 20 | O | 60 | 90 | 120 | 0 |
| 21 | O | 60 | 120 | 150 | 0 |
| 22 | O | 60 | 120 | 150 | 0 |
| 23 | O | 60 | 120 | 150 | 0 |
| 24 | O | 30 | 120 | 150 | 0 |
| Control | NA | 90 | 150 | 180 | NA |
| B | | | | | |
| 25 | L | 210 | ** | ** | >120 |
| Control | NA | 60 | 120 | 150 | NA |
| C | | | | | |
| 26 | L | 120 | 150 | 180 | 60 |

NA*—not applicable
**Product remained acceptable beyond the testing period
***Product did not become unacceptable within the testing period
⁺ND—not detected
⁺⁺—“L” is lecithin; “DM” is distilled monoglyceride with IV less than 50; “O” is other emulsifier

As can be seen from Table 3, all the tested fat compositions that included lecithin were effective at extending the time a biscuit remained acceptable over a heated hold time beyond where the respective control became marginally acceptable. The effect could be seen over the tested range of 3% to 8% by weight of the fat composition, and generally resulted in an extension of acceptable quality over control by at least 60 minutes. It is believed that higher levels of lecithin would be effective, but that flavor would likely be impacted as 10% lecithin in the fat chips is approached in this biscuit formulation. It's possible that amounts higher than 10% in chips could be effective without significantly impacting flavor in baked good formulations that contain less of the fat compositions (e.g., by leaving out a portion of the fat composition, or by substituting standard fat chips) or contain ingredients that mask the flavor of lecithin (e.g., containing chocolate, flavorants, or the like). Similarly, the tested distilled monoglycerides that had an IV of less than 50 were effective at extending acceptable quality by at least 30 minutes when used at a level of 7% in a fat composition. In contrast, other emulsifiers that were tested either did not extend the acceptable quality or, in some cases, shortened it (see, e.g., sample 24).

Similar results were found using a different formulation of biscuit dough formulated as freezer-to-oven dough suitable for food service and containing 10-20% by weight of fat composition 3, as well as a biscuit dough formulated as a refrigerator-to-oven dough suitable for use in a home kitchen and containing 10-20% by weight of fat composition 3.

Further experimentation found that lecithin added to a dough separately, rather than associated with a fat composition (e.g., incorporated or applied to the surface of a fat composition) resulted in poor eating quality overall, especially by resulting in a biscuit that balls up in the mouth and becomes hard to break down while chewing (i.e., excessive mass cohesiveness), regardless of heated hold time.

In addition to heated hold time, Control A and Sample 3 biscuits were made, cooked, and cooled to room temperature, and then stored in a sealed plastic storage bag overnight at room temperature. Control A and Sample 3 biscuits were similar after the overnight storage, exhibiting a soft crust rather than crispy, as when freshly baked, and a chewy center, with Sample 3 being slightly less chewy than Control A. After a 10 second reheat in a microwave, however, Sample 3 had a remarkably better eating quality. After microwaving, Control A was warm, but tough to chew, while Sample 3 was moister and more tender than Control A. The improvement in eating quality could be particularly beneficial for consumers who make more baked goods from a packaged dough than they can immediately consume because it improves the quality of baked goods that are reheated later.

### Example 3—Laminated Pastry Rolls

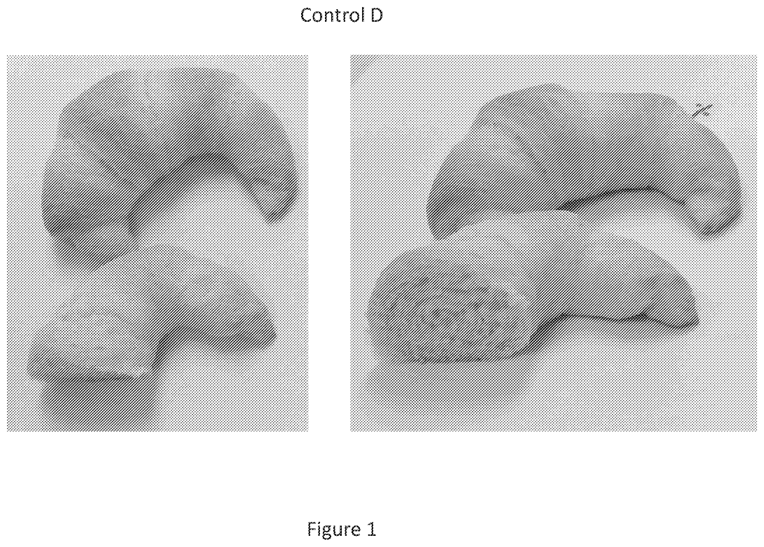

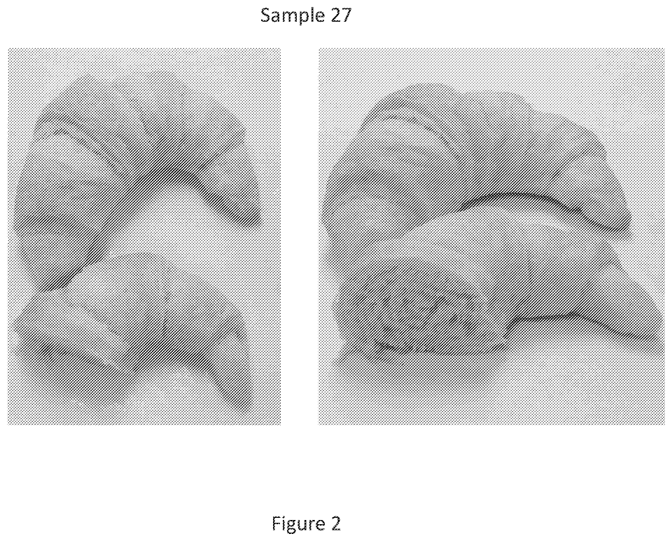

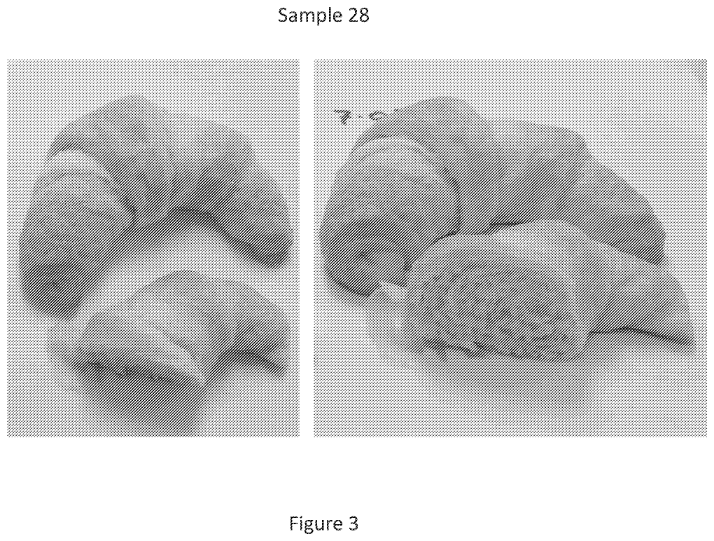

Laminated doughs formulated as refrigerated croissant-like pastry dough suitable for consumer packaged goods use were made using each of fat compositions 27, 28, and Control D to produce dough samples that were designated with the same number as the included fat composition from Table 2. The laminated doughs were formulated to contain 6% by weight of the respective fat composition. Generally, a dough of a croissant-like pastry product is characterized by a laminated structure of alternating thinly stretched dough layers separated by thin layers of fat that enhance oven rise and the development of crisp, flaky crust of the product. The laminated structure is typically created by repeated extrusion, rolling, and folding of dough and fat. To test the quality of a baked good made from each dough, the refrigerated dough was baked at 375° F. in a convection oven for 11-15 minutes to produce fully cooked croissant-like pastries (see, FIGS. 1-3). Following baking, it was observed that pastries made with Sample D produced a pastry with moderate flakiness (FIG. 1), while Sample 27 exhibited a greater degree of flakiness (FIG. 2), and Sample 28 was exceptionally flaky (FIG. 3). The eating qualities of each sample was acceptable, and while a change in flavor in Sample 28 was noticeable, it was not off-putting and Sample 28 was particularly liked, overall. Thus, increasing amounts of lecithin improved flakiness without negatively impacting flavor in a significantly manner.

The implementations described above and other implementations are within the scope of the following claims. One skilled in the art will appreciate that the present disclosure can be practiced with embodiments other than those disclosed. The disclosed embodiments are presented for purposes of illustration and not limitation.

1. A fat composition, the fat composition being anhydrous and solid at 20° C., and consisting of at least 99% by weight of a combination of:
a. a first component consisting of a bakery compatible fat in an amount of about 90% to about 97% by weight of the composition; and
b. a second component consisting of a lecithin, a distilled monoglyceride having an iodine value (IV) of less than 50, or a combination thereof, the second component included in an amount of about 3% to about 10% by weight of the composition.

2. The fat composition of claim 1, wherein the second component consists of a soy lecithin, a sunflower lecithin, or a rapeseed/canola lecithin.

3. The fat composition of claim 1, wherein the fat composition is in a form of chips or flakes.

4. The fat composition of claim 2, wherein the first component has a Mettler Dropping Point (MDP) of greater than 25° C., and consists essentially of (a) a palm oil, a palm oil fraction, palm kernel oil, a palm kernel oil fraction, a coconut oil, a coconut oil fraction, or any interesterified or non-interesterified combination thereof; or (b) an interesterified and/or non-interesterified combination of a liquid oil and a fully hydrogenated oil.

5-8. (canceled)

9. The fat composition of claim 1, wherein the fat composition is in a form of a laminating fat composition.

10. The fat composition of claim 1, wherein the first component has an MDP of greater than 25° C., and consists essentially of a blend of:
a. a hard fat consisting essentially of palm oil, a palm oil fraction, a fully hydrogenated palm oil or palm oil fraction, palm kernel oil, a palm kernel oil fraction, a fully hydrogenated palm kernel oil or palm kernel oil fraction, or any interesterified or non-interesterified combination thereof; and
b. a liquid oil.

11. (canceled)

12. A dough comprising the fat composition of claim 1.

13. A method of making a baked good, comprising cooking the dough of claim 12 to produce a ready-to-eat baked good or par-cooked baked good.

14. A baked good made according to the method of claim 13.

15. A method of making a packaged refrigerated or frozen dough, comprising:
a. combining a flour, water, and the fat composition of claim 1 to produce a dough;
b. forming the dough into portions;
c. refrigerating or freezing the portions; and
d. packaging the portions.

16. The method of claim 15, wherein the fat composition is in a form of chips or flakes, the chips or flakes are included in an amount of about 5% to about 25% by weight of the dough, the chips or flakes are distributed throughout the dough, and wherein the dough is a biscuit dough, a pizza dough, a bread dough, pie crust dough, or a pastry dough.

17. (canceled)

18. The method of claim 15, wherein the fat composition is in a form of a laminating fat composition, wherein the fat composition is included in an amount of about 5% to about 40% by weight of the dough, the dough contains the fat composition in laminated layers, and wherein the dough is a croissant dough or a puff pastry dough.

19. (canceled)

20. A packaged dough product, comprising packaged portions of refrigerated or frozen dough made according to the method of claim 15.

21. A method of making a baked good, comprising cooking a dough from the packaged dough product of claim 20 to produce a ready-to-eat baked good or par-cooked baked good.

22. A baked good made according to the method of claim 21.

23. A method of making a packaged baked good, comprising:
a. combining a flour, water, and the fat composition of claim 1 to produce a dough;
b. forming the dough into portions;
c. baking the portions to produce a baked good; and
d. packaging the baked good.

24. The method of claim 23, wherein the method comprises refrigerating or freezing the baked good, and wherein the baked good is a ready-to-eat, or a par baked refrigerated or frozen baked good.

25-26. (canceled)

27. The method of claim 23, wherein the fat composition is in a form of chips or flakes, the chips or flakes are included in an amount of 5% to about 25% by weight of the dough, the chips or flakes are distributed throughout the dough, and wherein the dough is a biscuit dough, a pizza dough, a bread dough, a pie crust dough, or a pastry dough.

28. (canceled)

29. The method of claim 23, wherein the fat composition is in a form of a laminating fat composition included in an amount of about 5% to about 40% by weight of the dough, the dough contains the fat composition in laminated layers, and wherein the dough is a croissant dough or a puff pastry dough.

30. (canceled)

31. A packaged baked good, comprising a baked good made according to the method of claim 23.
